(19) United States
(12) Patent Application Publication
(10) Pub. No.: US 2026/0177760 A1
(43) Pub. Date: Jun. 25, 2026

(54) ATTACHMENT/DETACHMENT TOOL FOR OPTICAL CONNECTORS

(71) Applicant: Fujikura Ltd., Tokyo (JP)

(72) Inventors: Tomoyuki Shinoda, Sakura-shi (JP); Toshiaki Nakajima, Sakura-shi (JP); Hidetoshi Katahira, Sakura-shi (JP); Hiroyuki Takamizawa, Sakura-shi (JP)

(73) Assignee: Fujikura Ltd., Tokyo (JP)

(21) Appl. No.: 19/119,948

(22) PCT Filed: May 19, 2023
(86) PCT No.: PCT/JP2023/018786

§ 371 Date: Apr. 10, 2025

(30) Foreign Application Priority Data
Oct. 13, 2022 (JP) 2022-164561

(51) Int. Cl. G02B 6/38

(52) U.S. Cl. CPC G02B 6/3898; G02B 6/3825; G02B 6/3866; G02B 6/3885; G02B 6/3893; G02B 6/3897

(57) ABSTRACT

An attachment/detachment tool for optical connectors that attach/detach an optical connector provided at an end portion of an optical fiber to/from a connection target, includes: a holder that holds the optical connector; an operation portion that causes the holder to hold the optical connector; and a guide disposed between the holder and the operation portion and that is guided by the optical fiber.

### TECHNICAL FIELD

The present invention relates to an attachment/detachment tool for optical connectors.

Priority is claimed on Japanese Patent Application No. 2022-164561, filed Oct. 13, 2022, the content of which is incorporated herein by reference.

### BACKGROUND

In a data center, a large number of optical connectors are connected to an adapter in order to construct an optical network. Patent Document 1 discloses an attachment/detachment tool for optical connectors for attaching/detaching the optical connectors to/from an adapter. The attachment/detachment tool is configured to pinch a boot portion of the optical connector with a pair of pinching pieces.

### PATENT LITERATURE

Patent Document 1: Japanese Patent No. 4098165

In the data center, work of searching for a specific optical connector from a large number of optical connectors connected to the adapter and pulling out the specific optical connector from the adapter is performed. In a case of performing this work, in many cases, a target optical fiber is specified first and then the optical fiber is followed to approach the optical connector. Here, due to an increase in network traffic, in the data center, an increase in a wiring density of the optical fiber and miniaturization of the optical connector are being accelerated. The conventional attachment/detachment tool has a structure in which the boot portion of the optical connector is simply pinched. Therefore, in some cases, it is difficult to cause the attachment/detachment tool to approach the optical connector provided at a distal end of the target optical fiber.

### SUMMARY

The present invention has been made in consideration of such circumstances, and one or more embodiments provide an attachment/detachment tool for optical connectors capable of easily performing an approach from an optical fiber to the optical connectors.

Aspect 1 of the present invention is an attachment/detachment tool for optical connectors that attach/detach an optical connector provided at an end portion of an optical fiber to/from a connection target, the attachment/detachment tool including: a holding portion that holds the optical connector; an operation portion that operates the holding portion to hold the optical connector; and a guide portion located between the holding portion and the operation portion and guided by the optical fiber.

Aspect 2 of the present invention is the attachment/detachment tool for optical connectors according to Aspect 1, in which the guide portion has an accommodating portion that accommodates a part of the optical fiber, and the accommodating portion includes an opening larger than a diameter of the optical fiber.

Aspect 3 of the present invention is the attachment/detachment tool for optical connectors according to Aspect 1 or 2, in which the holding portion has a rotating piece that rotates via the operation portion being operated, and a facing portion that faces the rotating piece, and an internal space of the accommodating portion communicates with a space between the rotating piece and the facing portion.

Aspect 4 of the present invention is the attachment/detachment tool for optical connectors according to any one of Aspects 1 to 3, in which the facing portion has a slide piece that slides toward the rotating piece via the operation portion being operated.

Aspect 5 of the present invention is the attachment/detachment tool for optical connectors according to any one of Aspects 1 to 4, in which the rotating piece has a first facing surface that faces the slide piece, and a first recess portion recessed from the first facing surface to be away from the slide piece, and the slide piece has a second facing surface that faces the first facing surface, and a second recess portion recessed from the second facing surface to be away from the rotating piece and that faces the first recess portion.

Aspect 6 of the present invention is the attachment/detachment tool for optical connectors according to any one of Aspects 1 to 5, in which the operation portion has a housing having a display window, a biasing member that biases the holding portion in a direction away from the operation portion, and a display portion disposed in the housing and displayed through the display window in a case where an external force applied to the holding portion in a direction approaching the operation portion exceeds a threshold value.

Aspect 7 of the present invention is the attachment/detachment tool for optical connectors according to any one of Aspects 1 to 6, in which the operation portion has a biasing member that biases the holding portion in a direction away from the operation portion, and an elastic piece that releases an elastic force in a case where an external force applied to the holding portion in a direction approaching the operation portion exceeds a threshold value.

Aspect 8 of the present invention is the attachment/detachment tool for optical connectors according to any one of Aspects 1 to 7, in which the holding portion has a plate-shaped guide plate portion that protrudes to a distal end side with respect to the rotating piece.

### Advantageous Effects of Invention

According to the above-described aspects of the present invention, it is possible to provide an attachment/detachment tool for optical connectors capable of easily performing an approach from an optical fiber to the optical connectors.

### BRIEF DESCRIPTION OF THE DRAWINGS

FIG. 1 An overall view of an attachment/detachment tool of one or more embodiments.

FIG. 2 A view showing a state where an optical connector is connected to or disconnected from an adapter using the attachment/detachment tool of FIG. 1.

FIG. 3 A perspective view of the vicinity of a holding portion of the attachment/detachment tool of FIG. 1.

FIG. 4 A perspective view of the holding portion of FIG. 3 in an approach state.

FIG. 5 A perspective view of the holding portion of FIG. 3 in which the optical connector is set.

FIG. 6 A sectional view taken along line VII-VII of FIG. 3.

FIG. 7 A view of the holding portion of FIG. 6 as viewed from an opposite side.

FIG. 8 A sectional view taken along line IX-IX of FIG. 2.

FIG. 9 A cross-sectional view showing a state in which a shaft member and the like of FIG. 8 are moved to a proximal end portion side.

FIG. 10 A view in which a housing and the like of an operation portion are omitted from FIG. 2.

FIG. 11 A view showing how the optical connector is set on the attachment/detachment tool.

FIG. 12 A view showing a step that follows FIG. 11.

### DETAILED DESCRIPTION

Hereinafter, an attachment/detachment tool for optical connectors of one or more embodiments (hereinafter, simply referred to as an attachment/detachment tool 1) is described with reference to the drawings.

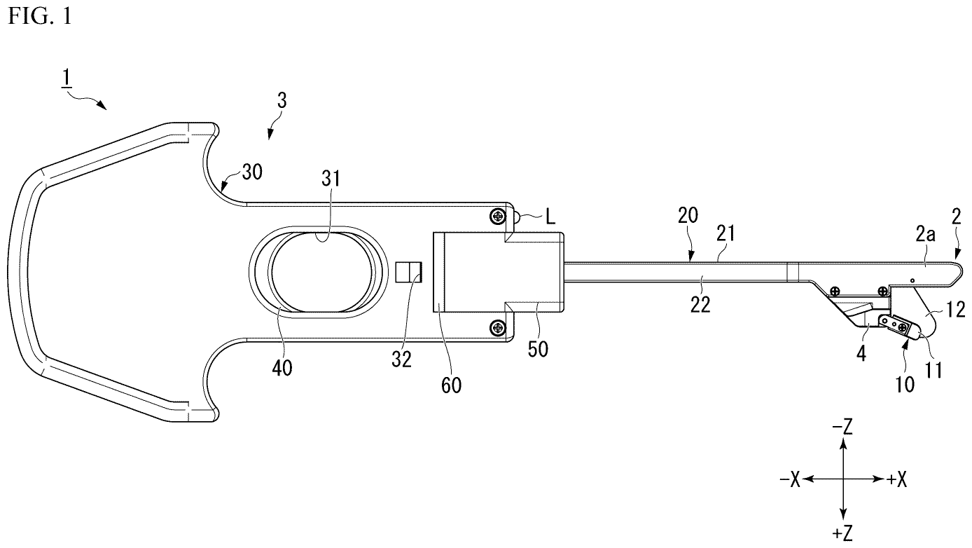

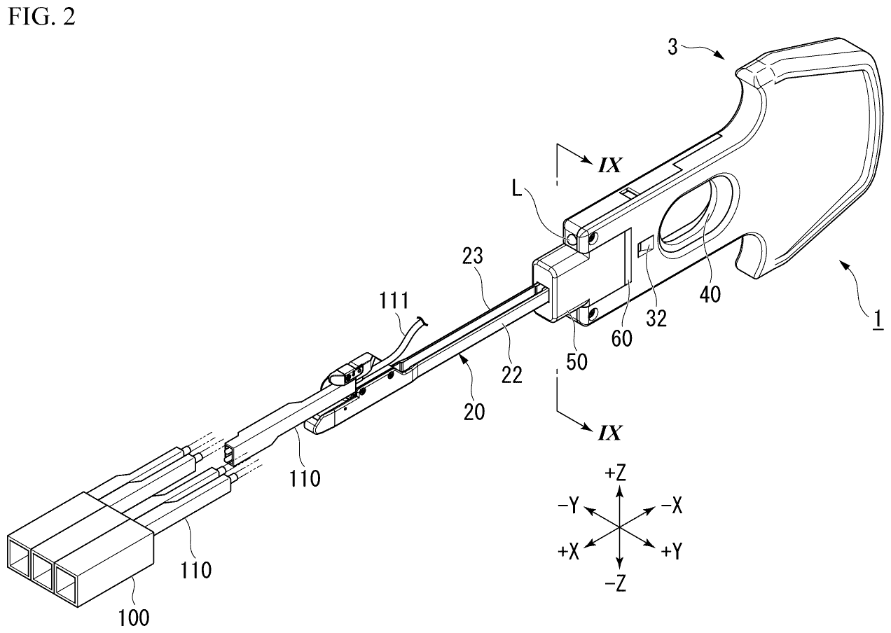

As shown in FIG. 1, the attachment/detachment tool 1 includes a holding portion 2 (i.e., holder), an operation portion 3, a guide portion 4, and a shaft member 20. As shown in FIG. 2, the attachment/detachment tool 1 is used to connect or disconnect an optical connector 110 to or from an adapter 100 (connection target). However, the connection target does not have to be the adapter 100.

The holding portion 2 is configured to hold the optical connector 110.

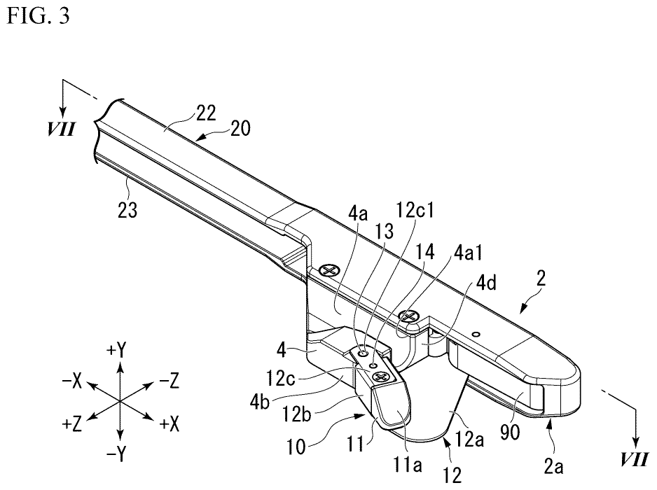

The operation portion 3 is a portion operated by the worker. The operation portion 3 includes a housing 30 and a lever 40. A finger hook hole 31 is formed in the housing 30. The lever 40 is accommodated inside the housing 30. A part of the lever 40 is exposed inside the finger hook hole 31. The worker inserts the fingers into the finger hook hole 31 and pulls the lever 40, so that the holding portion 2 is operated and can hold the optical connector 110. The guide portion 4 is a portion that is located between the holding portion 2 and the operation portion 3 and is guided by an optical fiber 111 connected to the optical connector 110. As shown in FIG. 3, the guide portion 4 has an accommodating portion 4a that can accommodate a part of the optical fiber 111. The number of the optical fibers 111 connected to one optical connector 110 may be one or two or more.

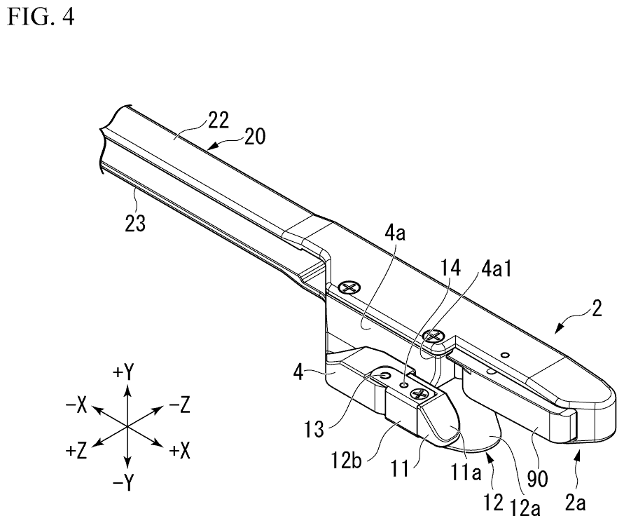

As shown in FIG. 3, the holding portion 2 includes a rotating portion 10 and a facing portion 2a facing the rotating portion 10. The rotating portion 10 includes a rotating piece 11, a first link 12, a rotating shaft 13, and a fixing pin 14. The rotating piece 11 and the first link 12 are rotated about the rotating shaft 13 in conjunction with the operation of the lever 40 in the operation portion 3. Accordingly, the posture of the rotating piece 11 is changed between a standby state (FIG. 3) in which the distal end of the rotating piece 11 is separated from the facing portion 2a and an approach state (FIG. 4) in which the distal end of the rotating piece 11 approaches the facing portion 2a. The fixing pin 14 fixes the rotating piece 11 and the first link 12.

The facing portion 2a has a slide piece 90 that is slidable. In one or more embodiments, the slide piece 90 holds the optical connector 110 together with the rotating piece 11. The slide piece 90 is slid in conjunction with the operation of the lever 40.

In a case where the rotating piece 11 is in the standby state (FIG. 3), the slide piece 90 is retracted to the inside of the shaft member 20. In a case where the rotating piece 11 is in the approach state (FIG. 4), the slide piece 90 protrudes from the shaft member 20 to approach the rotating piece 11.

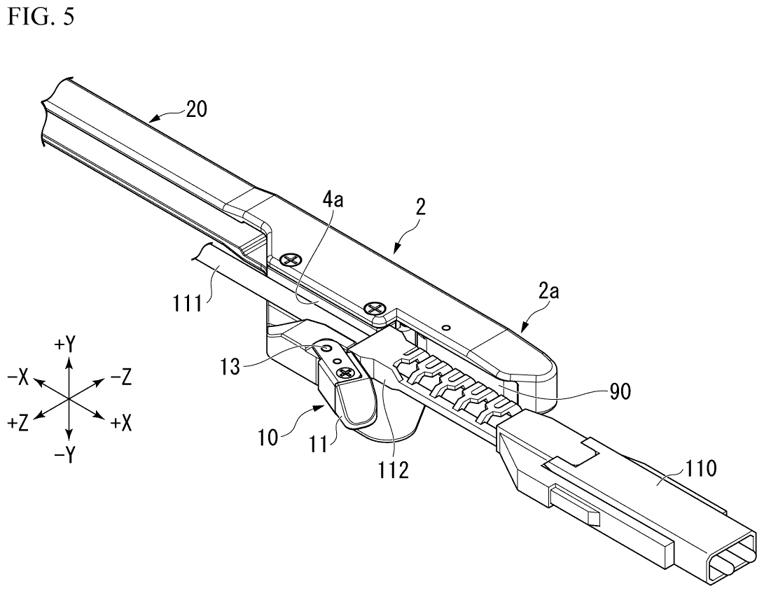

That is, the rotating piece 11 is rotated and the slide piece 90 is slid in conjunction with the operation of the lever 40. As shown in FIG. 5, by operating the lever 40 after the optical connector 110 is put between the rotating piece 11 and the facing portion 2a (slide piece 90) in a case where the holding portion 2 is in the standby state, the optical connector 110 is pinched between the rotating piece 11 and the slide piece 90.

In a case where the attachment/detachment tool 1 is pushed toward the adapter 100 in a state where the holding portion 2 holds the optical connector 110, the optical connector 110 can be connected to the adapter 100. This work is referred to as “connection work”. In addition, in a case where the attachment/detachment tool 1 is pulled with respect to the adapter 100 in a state where the optical connector 110 connected to the adapter 100 is held by the holding portion 2, the optical connector 110 can be pulled out from the adapter. This work is referred to as “disconnection work”.

The attachment/detachment tool 1 of one or more embodiments is configured to easily perform the connection work and the disconnection work. Hereinafter, a detailed structure of the attachment/detachment tool 1 will be described.

### Definition of Direction

In the present specification, a direction in which the operation portion 3 and the holding portion 2 are arranged is referred to as a front-rear direction X. The front-rear direction X coincides with a longitudinal direction of the optical fiber 111 accommodated in the accommodating portion 4a (see FIGS. 3 and 5). A side (+X side) on which the holding portion 2 is located in the front-rear direction X is referred to as a front side or a distal end side. A side (−X side) on which the operation portion 3 is located in the front-rear direction X is referred to as a rear side or a proximal end side. A direction in which the rotating piece 11 and the facing portion 2a face each other is referred to as an up-down direction Z. In the up-down direction Z, a side (+Z side) on which the rotating piece 11 is located is referred to as an upper side, and a side (−Z side) on which the facing portion 2a is located is referred to as a lower side. The front-rear direction X and the up-down direction Z are orthogonal to each other. A direction orthogonal to both the front-rear direction X and the up-down direction Z is referred to as a left-right direction Y. In the left-right direction Y, a side (+Y side) on which the accommodating portion 4a is open is referred to as a left side, and the opposite side (−Y side) is referred to as a right side. In addition, the up-down direction Z may not coincide with the vertical direction. In addition, the term “upper side” and the term “lower side” may not coincide with the upper side and the lower side in the vertical direction.

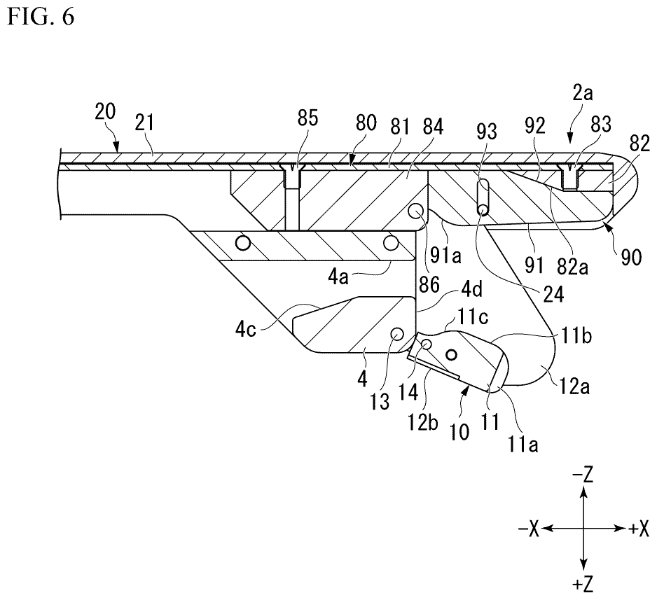

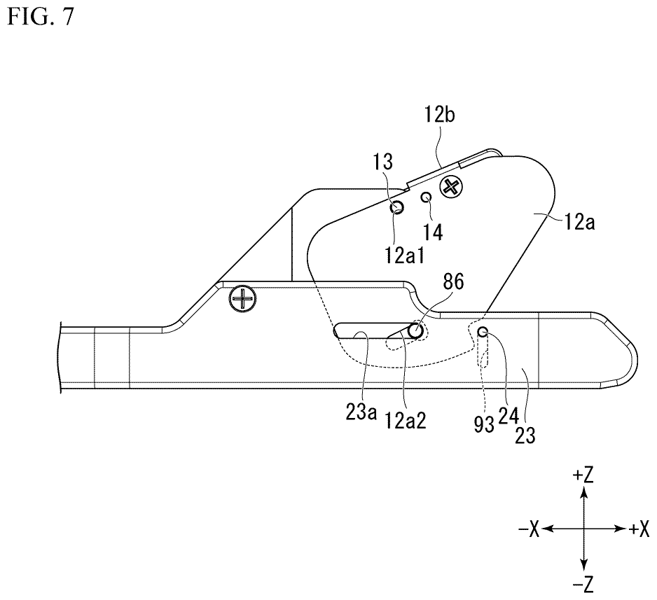

As shown in FIGS. 1 and 2, the shaft member 20 has a base portion 21, a first side wall 22, and a second side wall 23. The base portion 21 has a plate shape that extends in the front-rear direction X and the left-right direction Y. The first side wall 22 extends from the end edge of the base portion 21 on the +Y side to the +Z side, and the second side wall 23 extends from the end edge of the base portion 21 on the −Y side to the +Z side. The first side wall 22 and the second side wall 23 face each other in the left-right direction Y. Although not shown, the shaft member 20 has a C-shape that is open on the +Z side in a cross section orthogonal to the front-rear direction X. A guide shaft 24 (see FIGS. 6 and 7) is fixed to the shaft member 20. The guide shaft 24 extends in the left-right direction Y, and both ends of the guide shaft 24 are supported by the first side wall 22 and the second side wall 23. As shown in FIG. 7, a guide hole 23a extending in the front-rear direction X is formed in the second side wall 23.

As shown in FIG. 3, the guide portion 4 includes the accommodating portion 4a, a rotation support portion 4b, and a butting surface 4d. The accommodating portion 4a is a groove extending in the front-rear direction X. The accommodating portion 4a includes an opening 4al facing the +Y side. Further, the internal space of the accommodating portion 4a communicates with a space between the rotating piece 11 and the slide piece 90. The width (dimension in the up-down direction Z) of the opening 4al is larger than the thickness of the optical fiber 111. Therefore, the optical fiber 111 can be introduced into the accommodating portion 4a through the opening 4a1.

The accommodating portion 4a of one or more embodiments has a U-shape that is open toward the +Y side as viewed from the front-rear direction X. However, the shape of the accommodating portion 4a can be changed, and may be, for example, a C-shape opened on the +Y side. In this case, it is possible to suppress the optical fiber 111 introduced into the accommodating portion 4a from falling off from the accommodating portion 4a. The butting surface 4d is an end surface of the guide portion 4 on the +X side. As shown in FIG. 5, in a case where the holding portion 2 holds the optical connector 110, a boot 112 of the optical connector 110 is butted against the butting surface 4d.

As shown in FIG. 6, an inclined surface 4c is provided at a rear end portion (end portion on the −X side) of the accommodating portion 4a. The inclined surface 4c is inclined to face the +Z side as being closer to the −X side. Therefore, the width of the accommodating portion 4a in the up-down direction Z is widened as being closer to the −X side at the rear end portion of the accommodating portion 4a. With this shape, in a case where the attachment/detachment tool 1 is moved in a state where the optical connector 110 is held by the holding portion 2, it is possible to suppress the application of the stress to the optical fiber 111.

A through-hole extending in the left-right direction Y is formed in the rotation support portion 4b and the rotating shaft 13 is inserted through this through-hole. Both ends of the rotating shaft 13 protrude from the rotation support portion 4b to the +Y side and the −Y side. In one or more embodiments, the rotating shaft 13 is fixed to the guide portion 4 by press-fitting the rotating shaft 13 into the through-hole of the rotation support portion 4b. Meanwhile, the method of fixing the rotating shaft 13 to the guide portion 4 may be changed. In addition, the rotating shaft 13 and the guide portion 4 may be integrated.

As shown in FIG. 3, the rotating piece 11 has a first inclined surface 11a. The first inclined surface 11a is inclined to face the −Y side as being closer to the +X side. Accordingly, the thickness of the rotating piece 11 in the left-right direction Y decreases as the rotating piece 11 is closer to the +X side. Since the first inclined surface 11a is provided, in a state where the optical connectors 110 are connected to the adapter 100 with high density, it is easy to insert the holding portion 2 between the optical connectors 110.

As shown in FIG. 6, the rotating piece 11 has a first facing surface 11b and a first recess portion 11c. The first facing surface 11b faces the slide piece 90. The first recess portion 11c is recessed from the first facing surface 11b toward the +Z side. The first facing surface 11b is a portion in contact with the boot 112 (see FIG. 5) of the optical connector 110. A protrusion formed on the boot 112 enters the first recess portion 11c.

As shown in FIG. 3, the first link 12 includes a guide plate portion 12a, a connection portion 12b, and a support portion 12c. The guide plate portion 12a and the support portion 12c are disposed at an interval in the left-right direction Y. The connection portion 12b connects the guide plate portion 12a and the support portion 12c. The rotation support portion 4b of the guide portion 4 is sandwiched between the guide plate portion 12a and the support portion 12c. A first bearing hole 12al is formed in the guide plate portion 12a, and a second bearing hole 12cl is formed in the support portion 12c (see FIGS. 3 and 7). The rotating shaft 13 protruding from the rotation support portion 4b is inserted into the first bearing hole 12al and the second bearing hole 12c1. With this configuration, the first link 12 is rotatable about the rotating shaft 13. In addition, since the rotating piece 11 is fixed to the first link 12, the rotating piece 11 is also rotated about the rotating shaft 13.

As shown in FIG. 3, the guide plate portion 12a has a plate shape extending in the front-rear direction X and the up-down direction Z. The thickness of the guide plate portion 12a is smaller than the dimension of the rotating piece 11 in the left-right direction Y. The distal end portion (end portion on the +X side) of the guide plate portion 12a is curved to be projection on the +X side as viewed from the left-right direction Y. In addition, an end portion of the guide plate portion 12a on the +X side is located on the +X side with respect to the rotating piece 11. The presence of the guide plate portion 12a makes it easy to insert the holding portion 2 between the densely packed optical connectors 110. As shown in FIG. 7, an engagement hole 12a2 is formed in the guide plate portion 12a. A link pin 86 (described later) is inserted into the engagement hole 12a2.

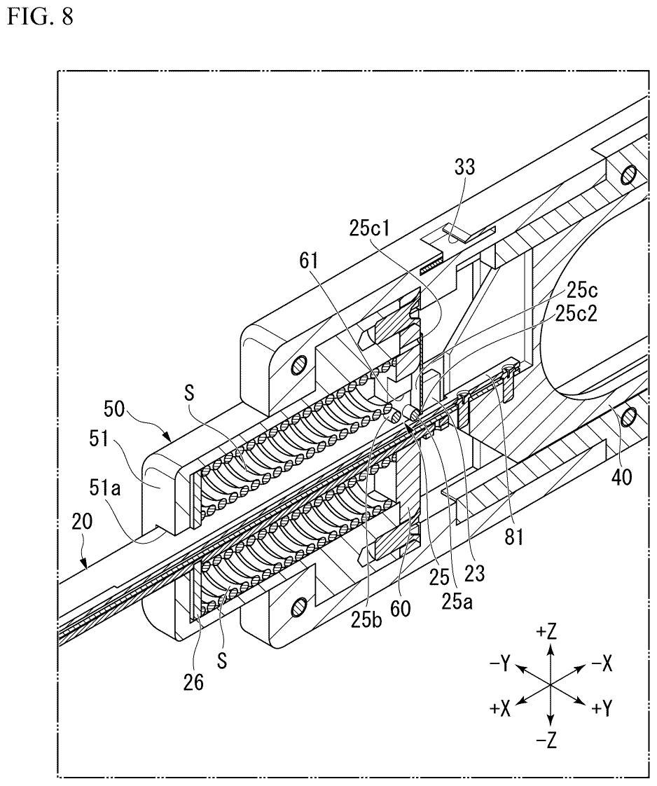

As shown in FIG. 6, a connecting portion 80 is disposed inside the shaft member 20. The connecting portion 80 connects the lever 40 of the operation portion 3 and the holding portion 2 and has a role of transmitting the operation of the lever 40 to the holding portion 2. The connecting portion 80 includes a connecting member 81, a cam member 82, and a second link 84. The connecting member 81 has a plate shape that extends in the front-rear direction X and the left-right direction Y. The connecting member 81 extends along the base portion 21 of the shaft member 20 and is located between the first side wall 22 and the second side wall 23. An end portion of the connecting member 81 on the −X side is fixed to the lever 40 (see FIG. 8). Meanwhile, the shaft member 20 is fixed to the housing 30. Therefore, in a case where the lever 40 is moved in the front-rear direction X with respect to the housing 30, the connecting member 81 is moved in the front-rear direction X with respect to the shaft member 20 in conjunction with the lever 40.

As shown in FIG. 6, the cam member 82 is fixed to the distal end of the connecting member 81 by a screw 83. The second link 84 is located on the −X side with respect to the cam member 82 and is fixed to the connecting member 81 by a screw 85. The cam member 82 and the second link 84 may be fixed to the connecting member 81 by fixing means (for example, adhesion, welding, or the like) other than the screws 83 and 85. In addition, a part or all of the cam member 82 and the second link 84 may be integrated with the connecting member 81.

The cam member 82 has a cam surface 82a. The cam surface 82a is inclined to face the −Z side as being closer to the −X side. The slide piece 90 has a second facing surface 91, a second recess portion 91a, an inclined surface 92, and an elongated hole 93. The second facing surface 91 faces the first facing surface 11b of the rotating piece 11. The second recess portion 91a is recessed from the second facing surface 91 to the −Z side and faces the first recess portion 11c in the up-down direction Z. The inclined surface 92 is inclined to face the −Z side as being closer to the −X side.

In a case where the cam member 82 is moved to the −X side in conjunction with the lever 40, the cam surface 82a and the inclined surface 92 slide, and a force directed to the +Z side acts on the slide piece 90. The slide piece 90 is moved to the +Z side by this force. The elongated hole 93 penetrates the slide piece 90 in the left-right direction Y and extends in the up-down direction Z. The guide shaft 24 fixed to the shaft member 20 is passed through the elongated hole 93. The elongated hole 93 and the guide shaft 24 guide the sliding of the slide piece 90 and have a role of preventing the slide piece 90 from falling off.

The link pin 86 is provided on the second link 84. The link pin 86 protrudes from the second link 84 toward the −Y side (see FIG. 7). In one or more embodiments, a through-hole is formed in the second link 84, and the link pin 86 is inserted into this through-hole. Meanwhile, the link pin 86 may be integrated with the second link 84. As shown in FIG. 7, the link pin 86 penetrates the engagement hole 12a2 of the guide plate portion 12a and is inserted into the guide hole 23a of the second side wall 23. In a case where the second link 84 is moved to the −X side in conjunction with the lever 40, the movement of the second link 84 is guided by the link pin 86 and the guide hole 23a. In addition, the link pin 86 and the engagement hole 12a2 are engaged with each other, so that the movement of the second link 84 toward the −X side is converted into the rotation about the rotating shaft 13 of the first link 12.

As shown in FIG. 1, an intermediate case 50 and a lid 60 are provided at an end portion of the operation portion 3 on the +X side. As shown in FIG. 8, the intermediate case 50 has a hollow box shape and has a front wall 51 facing the +X side. The intermediate case 50 is open toward the −X side, and the lid 60 is disposed to cover this opening. The lid 60 is fixed to the intermediate case 50 by fixing means such as a screw. The intermediate case 50 and the lid 60 are fixed to the housing 30 of the operation portion 3. A first insertion hole 51a is formed in the front wall 51 of the intermediate case 50. A second insertion hole 61 is formed in the lid 60. The shaft member 20 is inserted into the first insertion hole 51a and the second insertion hole 61, and the shaft member 20 penetrates the intermediate case 50 and the lid 60 in the front-rear direction X.

As shown in FIG. 8, a pressing portion 26 and two biasing members S are disposed inside the intermediate case 50. The pressing portion 26 has a plate shape extending in the up-down direction Z and the left-right direction Y, and is fixed to the shaft member 20. The two biasing members S are disposed to sandwich the shaft member 20 in the up-down direction Z. The front end (end portion on the +X side) of the two biasing members S is in contact with the pressing portion 26, and the rear end (end portion on the −X side) of the two biasing members S is in contact with the lid 60. With this configuration, the biasing members S bias the shaft member 20 and the holding portion 2 or the like provided at the distal end of the shaft member 20 to the +Z side.

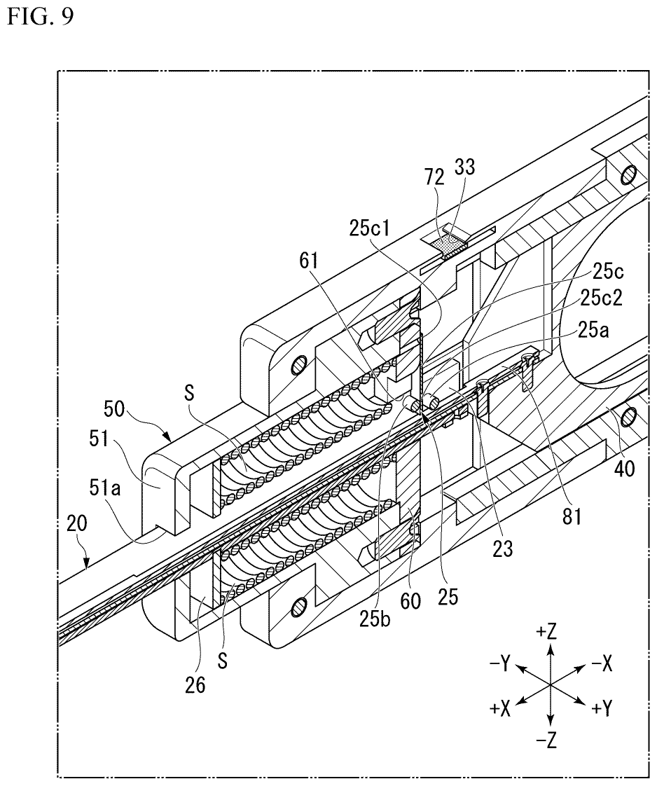

In a case where the optical connector 110 is pushed into the adapter 100 in a state where the holding portion 2 holds the optical connector 110, a force directed to the −X side acts on the shaft member 20. As shown in FIG. 9, in a case where the shaft member 20 is moved to the −X side, the pressing portion 26 fixed to the shaft member 20 approaches the lid 60. Therefore, the two biasing members S are compressed in the front-rear direction X between the pressing portion 26 and the lid 60. The biasing members S are, for example, coil springs. The number of the biasing members S may be one, or three or more. The amount of movement of the shaft member 20 toward the −X side and the repulsive force of the biasing members S at that time are substantially in a proportional relationship according to Hooke's law.

As shown in FIG. 8, the attachment/detachment tool 1 of one or more embodiments includes a sound generation mechanism 25. The sound generation mechanism 25 includes a locking portion 25a, a hitting portion 25b, an elastic piece 25c, and the like. The locking portion 25a and the hitting portion 25b are fixed to the shaft member 20. The locking portion 25a and the hitting portion 25b are pins extending in the left-right direction Y, and both ends of each of the locking portion 25a and the hitting portion 25b are supported by the first side wall 22 and the second side wall 23 of the shaft member 20. The elastic piece 25c is, for example, a metal or resin leaf spring, and is fixed to the lid 60. Specifically, the elastic piece 25c has a fixed end 25cl and a free end 25c2. The fixed end 25cl and the free end 25c2 are both ends of the elastic piece 25c in the up-down direction Z. The fixed end 25cl (in one or more embodiments, the end portion of the elastic piece 25c on the +Z side) is fixed to the lid 60, and the free end 25c2 (in one or more embodiments, the end portion of the elastic piece 25c on the −Z side) is not fixed.

The elastic piece 25c covers at least a part of the second insertion hole 61 of the lid 60. The hitting portion 25b is located on the +X side with respect to the locking portion 25a, and the elastic piece 25c is located on the −X side with respect to the locking portion 25a. In a case of being viewed from the front-rear direction X, the elastic piece 25c is disposed at a position overlapping both the locking portion 25a and the hitting portion 25b. The locking portion 25a is disposed at a position closer to the free end 25c2 of the elastic piece 25c than the hitting portion 25b in the up-down direction Z. In one or more embodiments, the locking portion 25a is located on the −Z side with respect to the hitting portion 25b.

In a case where the shaft member 20 is moved to the −X side, the locking portion 25a fixed to the shaft member 20 elastically deforms the elastic piece 25c toward the −X side. In a case where the locking portion 25a gets over the free end 25c2 of the elastic piece 25c to the −X side, the elastic piece 25c is restored and deformed. In this case, as shown in FIG. 9, the elastic piece 25c hits the hitting portion 25b, so that a sound is generated. A time at which the sound is generated is determined by the amount of movement of the shaft member 20 toward the −X side. In addition, the amount of movement of the shaft member 20 toward the −X side is in a proportional relationship with the repulsive force of the two biasing members S. In addition, the repulsive force of the two biasing members S is substantially the same as the push-in force with which the holding portion 2 pushes the optical connector 110 into the adapter 100 during the connection work.

Therefore, the sound generation mechanism 25 can generate a sound in a case where the push-in force exceeds a predetermined threshold value. The structure of the sound generation mechanism 25 may be appropriately changed as long as the sound generation mechanism 25 can operate as described above. For example, the locking portion 25a and the hitting portion 25b may be different portions in the same member, or the locking portion 25a and the hitting portion 25b may be integrated with the shaft member 20. In addition, the elastic piece 25c may be formed by a resin as being integrated with the lid 60. In addition, the hitting portion 25b may not be provided as long as a sound is generated in a case where the elastic piece 25c releases the elastic force.

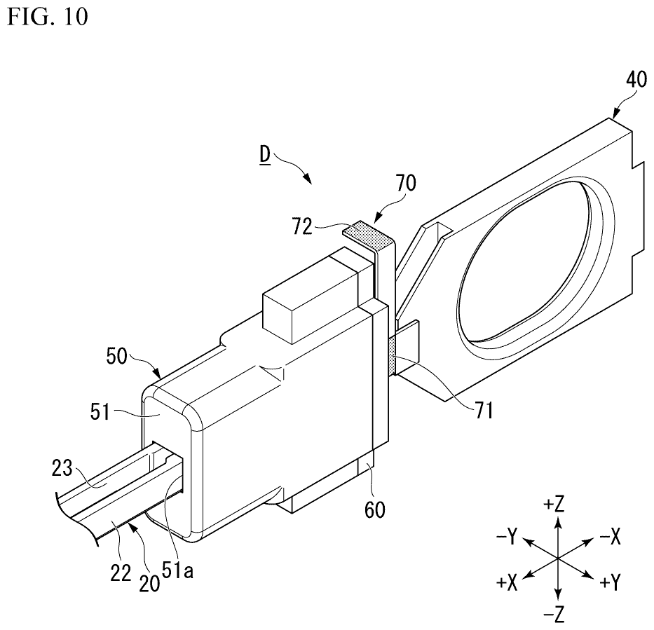

As shown in FIG. 10, the attachment/detachment tool 1 of one or more embodiments includes a display mechanism D. The display mechanism D has a display member 70, the housing 30 (see FIG. 1), and the like. The housing 30 of one or more embodiments has a structure in which two members are combined. Meanwhile, the number of members constituting the housing 30 can be changed appropriately. The housing 30 has display windows 32 and 33 (see FIGS. 1 and 8). The display window 32 faces the left-right direction Y, and the display window 33 faces the up-down direction Z.

The display member 70 is fixed to the shaft member 20. The display member 70 includes a plurality of display portions 71 and 72 (i.e., display marks). The display portions 71 and 72 may be colored, for example, or may be provided with characters, patterns, or the like. The display portion 71 is exposed through the display window 32 of the housing 30 in a case where the shaft member 20 is moved by a predetermined amount to the −X side. The display portion 72 is exposed through the display window 33 of the housing 30 in a case where the shaft member 20 is moved by a predetermined amount to the −X side (see FIGS. 8 and 9).

The display mechanism D can display the display portions 71 and 72 through the display windows 32 and 33 in a case where the push-in force exceeds the predetermined threshold value. For example, the display portions 71 and 72 may be blocked by the entire display windows 32 and 33 substantially at the same time as the sound generation mechanism 25 generates the sound. In addition, the display portions 71 and 72 may display scales such that the user can recognize the magnitude of the push-in force. The structure of the display mechanism D may be appropriately changed as long as the above-described operation is possible. For example, the number of display windows and display portions may be one.

As shown in FIG. 2, the attachment/detachment tool 1 includes a light L. The light L is provided at a front end of the housing 30. However, the disposition of the light L can be changed as appropriate. The operation portion 3 is provided with a switch (not shown) for turning on the light L. For example, in a case where the optical connector 110 is connected to the adapter 100 with high density, there is no light on the periphery of the adapter 100, and it may be difficult to visually recognize the periphery of the adapter 100. In such a case, the light L can be turned on to illuminate the periphery of the adapter 100. Accordingly, the connection work and the disconnection work can be more easily performed. The attachment/detachment tool 1 may not include the light L.

Next, a method for using the attachment/detachment tool 1 configured as described above will be described. The following description is merely an example, and other use methods are acceptable.

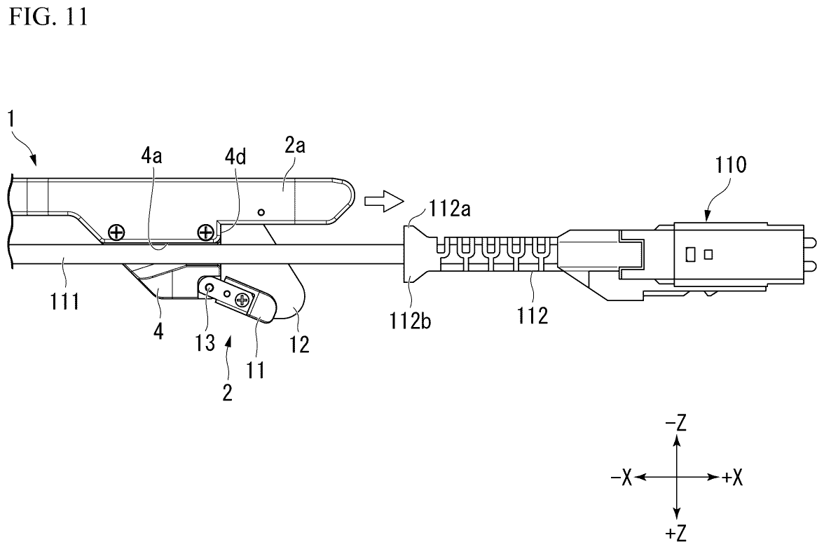

In a case where the connection work is performed, first, as shown in FIG. 11, a part of the optical fiber 111 is accommodated in the accommodating portion 4a of the guide portion 4. In this case, the holding portion 2 is in a state of being separated from the optical connector 110 in the front-rear direction X.

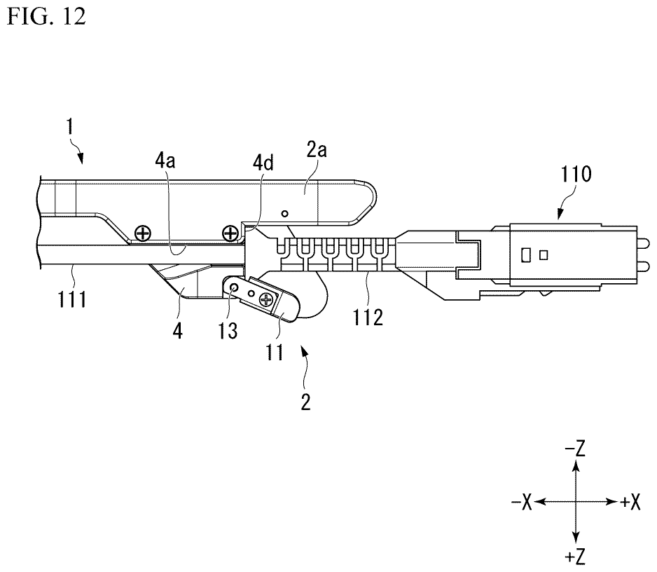

Next, as shown in FIG. 12, the attachment/detachment tool 1 is caused to approach the optical connector 110. In this case, the holding portion 2 is in a standby state (that is, the rotating piece 11 is in a state of being opened with respect to the facing portion 2a). In a state where the boot 112 of the optical connector 110 is butted against the butting surface 4d of the guide portion 4, the lever 40 of the operation portion 3 is pulled. Accordingly, the first link 12 and the like are operated via the connecting portion 80, and the rotating piece 11 is rotated to approach the facing portion 2a. At the same time, the cam member 82 and the like also operate, and the slide piece 90 is slid to approach the rotating piece 11. Therefore, the boot 112 can be pinched between the slide piece 90 and the rotating piece 11.

As shown in FIG. 11, the boot 112 may be provided with protrusions 112a and 112b. In this case, the protrusions 112a and 112b each enter the first recess portion 11c and the second recess portion 91a (see FIG. 6). That is, it is possible to avoid the protrusions 112a and 112b from inhibiting the holding portion 2 from gripping the boot 112. Therefore, the boot 112 can be gripped more reliably. In a case where the boot 112 does not have such protrusions, the first recess portion 11c and the second recess portion 91a may not be provided. In a case where the optical connector 110 is pushed into the adapter 100 in a state where the holding portion 2 grips the boot 112, the optical connector 110 can be connected to the adapter 100. This completes the connection work.

In a case of performing the disconnection work, the target optical fiber 111 is searched for from a plurality of the optical fibers 111 connected to the adapter 100. The target optical fiber 111 is accommodated in the accommodating portion 4a of the guide portion 4 of the attachment/detachment tool 1. In this state, the attachment/detachment tool 1 is caused to approach the optical connector 110 by sliding the accommodating portion 4a with respect to the optical fiber 111 and following the optical fiber 111. By performing such work, it is possible to prevent the wrong optical connector 110 from being pulled out.

Subsequently, the attachment/detachment tool 1 is caused to approach the optical connector 110, and the optical connector 110 is put between the rotating piece 11 and the slide piece 90. The boot 112 is butted against the butting surface 4d of the guide portion 4. In this state, in a case where the lever 40 of the operation portion 3 is pulled, the optical connector 110 can be held by the holding portion 2. The optical connector 110 is pulled out from the adapter 100 by pulling the attachment/detachment tool 1. This completes the disconnection work.

Here, in a case where the push-in force of the optical connector 110 with respect to the adapter 100 is insufficient in a case of performing the connection work, optical connection may not be appropriately performed. In addition, in a case where the push-in force is excessive, there is a possibility of damage to the adapter 100 or the like. In a case where the connection work is performed using the attachment/detachment tool 1, it is difficult to adjust the force compared to a case where the connection work is performed with bare hands. In addition, depending on the type of the optical connector 110, a click feeling may occur in a case where the optical connector 110 is inserted into the adapter 100, but it is also assumed that the user cannot perceive the click feeling in a case where the attachment/detachment tool 1 is used.

Therefore, the attachment/detachment tool 1 of one or more embodiments includes the sound generation mechanism 25 and the display mechanism D. The sound generation mechanism 25 generates a sound in a case where the push-in force exceeds the predetermined threshold value. In addition, the display mechanism D displays the display portions 71 and 72 from the display windows 32 and 33 in a case where the push-in force exceeds the predetermined threshold value. Therefore, the worker can recognize that the push-in force has reached the threshold value by listening to the sound generated by the sound generation mechanism 25 or visually recognizing the display windows 32 and 33. As a result, it is easy to apply a push-in force without excess or deficiency, and the connection work can be appropriately performed.

Table 1 shows the results of the experiment on the push-in force.

TABLE 1

| | Load during connection (kgf) | | | | |
|---|---|---|---|---|---|
| Sample | First time | Second time | Third time | max − min | average |
| 1 | 1.70 | 1.75 | 1.85 | 0.15 | 1.77 |
| 2 | 1.50 | 1.55 | 1.40 | 0.15 | 1.48 |
| 3 | 1.25 | 1.40 | 1.30 | 0.15 | 1.32 |
| 4 | 1.35 | 1.25 | 1.35 | 0.10 | 1.32 |
| 5 | 0.95 | 1.05 | 1.05 | 0.10 | 1.02 |
| 6 | 1.25 | 1.45 | 1.40 | 0.20 | 1.37 |

| | max | min | max − min | average |
|---|---|---|---|---|
| TOTAL | 1.85 | 0.95 | 0.90 | 1.38 |

As shown in Table 1, six MDC type optical connectors 110 of Samples 1 to 6 were inserted three times each into the adapter 100, and the maximum load (kgf) at that time was measured. The measurement result is shown in Table 1 as the load during connection. For example, for Sample 1, the maximum load (load during connection) in a case of first insertion was 1.70 kgf. The result of the aggregation of the data for three times each of Samples 1 to 6 is displayed in the column of TOTAL in Table 1. max is a maximum value, min is a minimum value, max-min is the difference between the maximum value and the minimum value, and average is the average value.

According to Table 1, in the third connection of Sample 1, the load during connection was the largest, which was 1.85 kgf. Based on this result, the threshold value in the sound generation mechanism 25 or the display mechanism D may be, for example, 3 kgf. That is, in a case where the push-in force exceeds 3 kgf, the sound generation mechanism 25 may generate a sound and the display mechanism D may display the display portions 72 and 73. As a result, it is possible to suppress the occurrence of the connection failure of the optical connector 110 due to the insufficient push-in force. In addition, since the user only needs to stop the pushing-in of the attachment/detachment tool 1 in a case where the push-in force exceeds 3 kgf, it is also possible to suppress the attachment/detachment tool 1 from being pushed in by an excessive force.

As described above, one or more embodiments provide the attachment/detachment tool 1 for attaching/detaching the optical connector 110 provided at the end portion of the optical fiber 111 to/from the connection target (for example, the adapter 100). The attachment/detachment tool 1 includes the holding portion 2 that holds the optical connector 110, the operation portion 3 that operates the holding portion 2 to hold the optical connector 110, and the guide portion 4 that is located between the holding portion 2 and the operation portion 3 and is guided by the optical fiber 111. According to this configuration, as shown in FIGS. 11 and 12, it is possible to cause the attachment/detachment tool 1 to approach the optical connector 110 by following the optical fiber 111 while allowing the optical fiber 111 to guide the guide portion 4. Therefore, for example, even in a state where the optical connectors 110 are densely packed, it is possible to cause the attachment/detachment tool 1 to easily approach the predetermined optical connector 110.

In addition, the guide portion 4 includes the accommodating portion 4a that accommodates a part of the optical fiber 111, and the accommodating portion 4a includes the opening 4al that is larger than the diameter of the optical fiber 111. According to this configuration, a part of the optical fiber 111 can be easily accommodated in the accommodating portion 4a. Accordingly, the work of causing the attachment/detachment tool 1 to approach the optical connector 110 by following the optical fiber 111 is also easier.

In addition, the holding portion 2 has the rotating piece 11 that rotates via the operation portion 3 being operated, and the facing portion 2a that faces the rotating piece 11, and the internal space of the accommodating portion 4a communicates with a space between the rotating piece 11 and the facing portion 2a. According to this configuration, after the attachment/detachment tool 1 is caused to approach the optical connector 110 by following the optical fiber 111, the optical connector 110 can be smoothly introduced into the space between the rotating piece 11 and the facing portion 2a. The rotating piece 11 is rotated by the operation of the operation portion 3, and thus the optical connector 110 can be easily held.

In addition, the facing portion 2a includes the slide piece 90 that slides toward the rotating piece 11 by operating the operation portion 3. According to this configuration, the stroke of the holding operation of the optical connector 110 in the holding portion 2 increases by the amount of sliding of the slide piece 90. Accordingly, in a state before the optical connector 110 is held, it is possible to largely open the space between the facing portion 2a and the rotating piece 11. Accordingly, the operation of positioning the optical connector 110 between the facing portion 2a and the rotating piece 11 is easier.

In addition, the rotating piece 11 has the first facing surface 11b that faces the slide piece 90, and the first recess portion 11c that is recessed from the first facing surface 11b to be away from the slide piece 90, and the slide piece 90 has the second facing surface 91 that faces the first facing surface 11b, and the second recess portion 91a that is recessed from the second facing surface 91 to be away from the rotating piece 11 and faces the first recess portion 11c. According to this configuration, the protrusions 112a and 112b that the boot 112 of the optical connector 110 has can be put into the first recess portion 11c and the second recess portion 91a. Therefore, the boot 112 can be pinched between the first facing surface 11b and the second facing surface 91.

In addition, the operation portion 3 has the housing 30 having the display windows 32 and 33, the biasing member S that biases the holding portion 2 in the direction away from the operation portion 3, and the display portions 71 and 72 that are disposed in the housing 30 and displayed through the display windows 32 and 33 in a case where an external force applied to the holding portion 2 in a direction approaching the operation portion 3 exceeds a threshold value. According to this configuration, the display portions 71 and 72 are displayed in the display windows 32 and 33 in a case where the push-in force of the optical connector 110 to the adapter 100 exceeds a predetermined threshold value. Therefore, the user can recognize that the push-in force exceeds the threshold value by visually recognizing the display windows 32 and 33, and can suppress the excess and deficiency of the push-in force.

In addition, the operation portion 3 has the biasing member S that biases the holding portion 2 in the direction away from the operation portion 3, and the elastic piece 25c that releases an elastic force in a case where the external force applied to the holding portion 2 in the direction approaching the operation portion 3 exceeds the threshold value. According to this configuration, a sound is generated by the elastic piece 25c in a case where the push-in force of the optical connector 110 to the adapter 100 exceeds the predetermined threshold value. Therefore, the user can recognize that the push-in force exceeds the threshold value by listening to this sound, and can suppress the excess and deficiency of the push-in force.

In addition, the holding portion 2 has the plate-shaped guide plate portion 12a that protrudes to a distal end side with respect to the rotating piece 11. According to this configuration, in a case where a plurality of the optical connectors 110 are densely connected to the adapter 100, it is possible to cause the attachment/detachment tool 1 to approach the optical connectors 110 by inserting the guide plate portion 12a between the optical connectors 110. Accordingly, the approach of the attachment/detachment tool 1 to the optical connector 110 is easier.

Note that, the technical scope of the present invention is not limited to the above-described embodiments, and various modifications can be made without departing from the spirit of the present invention.

For example, the attachment/detachment tool 1 of the embodiments include the guide portion 4 for guiding the attachment/detachment tool 1 to the optical connector 110 by the optical fiber 111. However, an attachment/detachment tool that does not have such a guide function and is provided with only the sound generation mechanism 25, for example, may be employed. Even in this case, an effect that the connection work can be performed more reliably is obtained by generating a sound in a case where the push-in force with which the holding portion 2 pushes the optical connector 110 into the adapter 100 exceeds a predetermined threshold value.

Similarly, an attachment/detachment tool that does not have the guide function and is provided with only the display mechanism D may be employed. Even in this case, the display is performed in a case where the push-in force with which the holding portion 2 pushes the optical connector 110 into the adapter 100 exceeds the predetermined threshold value, whereby the effect that the connection work can be performed more reliably is obtained.

In addition, in one or more embodiments, the optical connector 110 is held by the slide piece 90 and the rotating piece 11. Meanwhile, the attachment/detachment tool 1 may not include the slide piece 90. For example, a configuration in which the optical connector 110 is held between a portion that is not in conjunction with the operation of the lever 40 and the rotating piece 11 can also be employed. Alternatively, the slide piece 90 can be replaced with a member that rotates in conjunction with the operation of the lever 40.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Attachment/detachment tool
2 Holding portion
2a Facing portion
3 Operation portion
4 Guide portion
4a Accommodating portion
11 Rotating piece
11b First facing surface
11c First recess portion
12a Guide plate portion
25c Elastic piece
30 Housing
32, 33 Display window
71, 72 Display portion
90 Slide piece
91 Second facing surface
91a Second recess portion
110 Optical connector
111 Optical fiber
S Biasing member

1. An attachment/detachment tool for optical connectors that attach/detach an optical connector provided at an end portion of an optical fiber to/from a connection target, the attachment/detachment tool comprising:
a holder that holds the optical connector;
an operation portion that causes the holder to hold the optical connector; and
a guide disposed between the holder and the operation portion and that is guided by the optical fiber.

2. The attachment/detachment tool for optical connectors according to claim 1, wherein the guide comprises an accommodating portion that accommodates a part of the optical fiber and that has an opening larger than a diameter of the optical fiber.

3. The attachment/detachment tool for optical connectors according to claim 2, wherein
the holder comprises:
a rotating piece that rotates by operation of the operation portion; and
a facing portion that faces the rotating piece, and
an internal space of the accommodating portion communicates with a space between the rotating piece and the facing portion.

4. The attachment/detachment tool for optical connectors according to claim 3, wherein the facing portion comprises a slide piece that slides toward the rotating piece by the operation of the operation portion.

5. The attachment/detachment tool for optical connectors according to claim 4, wherein
the rotating piece has:
a first facing surface that faces the slide piece, and
a first recess recessed from the first facing surface farther away from the slide piece, and
the slide piece has:
a second facing surface that faces the first facing surface, and
a second recess recessed from the second facing surface farther away from the rotating piece and that faces the first recess.

6. The attachment/detachment tool for optical connectors according to claim 1, wherein
the operation portion comprises:
a housing having a display window;
a biasing member that biases the holder in a direction away from the operation portion; and
a display mark disposed in the housing and configured to be visible through the display window in response to an external force applied to the holder in a direction approaching the operation portion exceeding a threshold.

7. The attachment/detachment tool for optical connectors according to claim 1, wherein
the operation portion comprises:
a biasing member that biases the holder in a direction away from the operation portion; and
an elastic piece that releases an elastic force in response to an external force applied to the holder in a direction approaching the operation portion exceeding a threshold.

8. The attachment/detachment tool for optical connectors according to claim 3, wherein the holder comprises a plate-shaped guide plate that protrudes towards an end of the attachment/detachment tool closer to the holder more than the rotating piece protrudes.
